(19) United States
(12) Patent Application Publication
(10) Pub. No.: US 2013/0287162 A1
(43) Pub. Date: Oct. 31, 2013

(54) INTEGRATED PROCESS FOR WATER-HYDROGEN-ELECTRICITY NUCLEAR GAS-COOLED REACTOR

(71) Applicant: KOREA ADVANCED INSTITUTE OF SCIENCE AND TECHNOLOGY, Daejon (KR)

(72) Inventors: Hee Cheon No, Daejeon (KR); Young-Soo Kim, Seoul (KR); Hosik Kim, Daejeon (KR); Ho Joon Yoon, Daejeon (KR); Hyung Gon Jin, Daejeon (KR); Byong Guk Jeon, Seoul (KR); Jinyoung Choi, Busan (KR); Jeong Ik Lee, Daejeon (KR)

(21) Appl. No.: 13/929,940

(22) Filed: Jun. 28, 2013

Related U.S. Application Data
(63) Continuation-in-part of application No. 12/906,506, filed on Oct. 18, 2010.

(30) Foreign Application Priority Data
Nov. 3, 2009 (KR) 10-2009-0105448

(51) Int. Cl. G21D 9/00; G21D 5/08

(52) U.S. Cl. CPC G21D 9/00; G21D 5/08
USPC 376/323

(57) ABSTRACT

Disclosed herein is an integrated process for production of electricity, hydrogen, and water using a high-temperature gas-cooled reactor as a single source, comprising: the high-temperature gas-cooled reactor, a power conversion unit connected directly or indirectly with the high-temperature gas-cooled reactor to receive heat produced by a reactor core of the high-temperature gas-cooled reactor and drive a gas turbine by the heat, thereby producing electricity through an electric generator, a hydrogen production unit that produces hydrogen by receiving the heat produced by the high-temperature gas-cooled reactor and/or the electricity produced by the electric generator, an electrical desalination unit that produces water by using the electricity produced by the electric generator, and a thermal desalination unit that produces water by distilling fresh water from salt water with waste heat recovered from a precooler and an intercooler of the power conversion unit.

### CROSS-REFERENCES TO RELATED APPLICATIONS

This patent application claims the benefit of priority under 35 U.S.C.§119 from Korean Patent Application No. 10-2009-0105448 filed Nov. 3, 2009, the contents of which are incorporated herein by reference, and is a Continuation in Part of co-pending application Ser. No. 12/906,506, filed Oct. 18, 2010.

### BACKGROUND OF THE INVENTION

1. Field of the Invention

The present disclosure relates to an integrated process for production of water, hydrogen, and electricity using a high-temperature gas-cooled reactor.

2. Description of the Related Art

As energy consumption rapidly increases worldwide, concerns about unstable price and exhaustion of fossil fuels are increasing and, accordingly, attentions are drawn to stable security of energy. Moreover, water-scarce regions are increasing throughout the globe due to abnormal climate of recent days. To this end, production of clean energy and water becomes essential for improvement of life quality of human beings, and various relevant technologies are shown up.

Especially, nuclear energy does not produce greenhouse gas and toxic gases such as CO₂, NOx, SOx, and so on and has a high efficiency enabling stable energy supply. Accordingly, the nuclear energy is being spotlighted as a promising clean energy source.

A high-temperature gas-cooled reactor (HTGR) is capable of supplying a high temperature heat source whereas it requires a relatively smaller plant in comparison with general nuclear power plants. In addition, since the HTGR has passive safety features in removing decay heat in case of an accident, the HTGR may be widely used from production of electricity to production of hydrogen through decomposition of water.

Hydrogen energy can be produced by decomposing water into oxygen and hydrogen with energy supplied from a reactor, thereby producing a large amount of hydrogen. Generally, for this, studies are in progress on a thermo-chemical process, an electrolysis process, a hybrid process combining the above processes, a high-temperature steam electrolysis process that produces hydrogen by generating steam by high-temperature heat and electrolyzing the steam, and so forth.

Especially, an iodine-sulfur cycle (IS cycle) among the thermo-chemical processes is known as the most prospective hydrogen production process. The IS cycle has actively been studied in the U.S., Korea, Japan, France, Italy, and so on since first introduced by General Atomics (GA) of the U.S. in early 1980s. The IS cycle includes three processes, that is, a Bunsen reaction process, a H₂SO₄ decomposition process, and a hydrogen iodide (HI) decomposition process. According to the IS cycle, water (H₂O) is decomposed by high heat of about 950° C. supplied from a high-temperature gas reactor, thereby producing hydrogen (H₂) and oxygen (O₂).

However, the IS cycle of GA has some limits. An efficiency of the Bunsen reaction process is limited due to an azeotropic point of the HI. In addition, the combination of high-temperature high-pressure operating condition and strong acid reactants are very corrosive to structural materials. Therefore, high-temperature low-pressure conditions are preferred to prevent corrosion of structural materials. However, operating under the high-temperature lower-pressure conditions is restricted in practice due to difficulties in safety and economy caused by a differential pressure between the reactor side and hydrogen side. Accordingly, solutions to overcome the difficulties are necessary.

Besides, the Hybrid Sulfur thermo-chemical process of Westinghouse in late 1970s produces hydrogen by electrolyzing sulphuric acid and decomposes SO₃ into SO₂ and O₂ through a thermo-chemical process.

The desalination market is increasing by growing 16.6% every year. Various large-scale desalination plants are being constructed to meet demands increasing due to climate change and desertification.

In general, desalination methods using distillation of water, such as a multi-stage flash distillation (MSF) process and a multiple effect distillation (MED) process, are used in desalination facilities. Although high-purity water can be obtained through the above methods, those methods require large energy consumption. In addition, there are a reverse osmosis (RO) process and a forward osmosis (FO) process, which are membrane processes. When the RO and the FO processes are used, less energy is consumed compared to the distillation process. However, maintenance and repair costs increase due to periodic washing and replacement of a filter and a permeable membrane. Furthermore, a hybrid process may be used to increase the fresh water productivity. The hybrid process is suggested by Doosan Heavy Industries and Construction as disclosed in Korean Patent Laid-open No. 2009-0067902.

Recently, studies are actively performed to commercialize a capacitive deionization (CDI) process which performs desalination through electrical adsorption by using a super capacitor.

As above mentioned, electricity, hydrogen, fresh water production processes are being studied, and those processes are separately performed according to related arts. Therefore, efficiency in use of the heat source is low.

To solve such waste of the heat source, U.S. Patent Laid-open No. 2004/0237526 shown in FIG. 1 introduces an L&N cycle capable of producing hydrogen, electricity, and water simultaneously by 1) a chemo-thermal process to convert water into oxygen and hydrogen, 2) a modified Regenerative Brayton cycle to produce electricity, 3) a thermal flash distillation desalination cycle, 4) an RO desalination cycle, and 5) an ion-exchange mineral extraction system. However, the above system chemo-thermally decomposes water into hydrogen and oxygen using a high-temperature heat source and then uses the high-temperature hydrogen and oxygen as a working fluid for production of water and electricity. That is, the heat source is intensively used for production of hydrogen.

To this end, the present inventors have studied to simultaneously produce electricity, water, and hydrogen, which are essential for life, using a single heat source, and to optimize the production ratio among the respective processes according to users' demands. As a result, there is devised an integrated system capable of producing electricity, hydrogen, and water simultaneously by supplying heat energy generated from a high-temperature gas-cooled reactor to a power conversion unit, a hydrogen production unit, and a desalination unit, and also capable of adjusting the production ratio of electricity, hydrogen, and water according to users' demands, which will be introduced as embodiments of the present invention.

### SUMMARY OF THE INVENTION

Embodiments of the present invention are directed to provide an integrated process for production of water, hydrogen, and electricity by using a high-temperature gas-cooled reactor (HTGR) as a single heat source.

According to an aspect of the present invention, there is provided an integrated process for production of electricity, hydrogen, and water using a high-temperature gas-cooled reactor, comprising the high-temperature gas-cooled reactor that produces a high-temperature heat source by using helium (He) as a working fluid, a power conversion unit connected directly or indirectly with the high-temperature gas-cooled reactor to receive heat produced by a reactor core of the high-temperature gas-cooled reactor and drive a gas turbine by the heat, thereby producing electricity through an electric generator, a hydrogen production unit that produces hydrogen by receiving the heat produced by the high-temperature gas-cooled reactor and/or the electricity produced by the electric generator, an electrical desalination unit that produces water by using the electricity produced by the electric generator, and a thermal desalination unit that produces water by distilling fresh water from salt water with waste heat recovered from a precooler and an intercooler of the power conversion unit.

As described above, the present invention has an effect of adjusting production quantities of electricity, hydrogen, and water according to users' demands and considerably increasing heat utilization rate by using a single heat source for multiple purposes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating an L&N cycle that produces hydrogen, electricity, and water according to a related art;

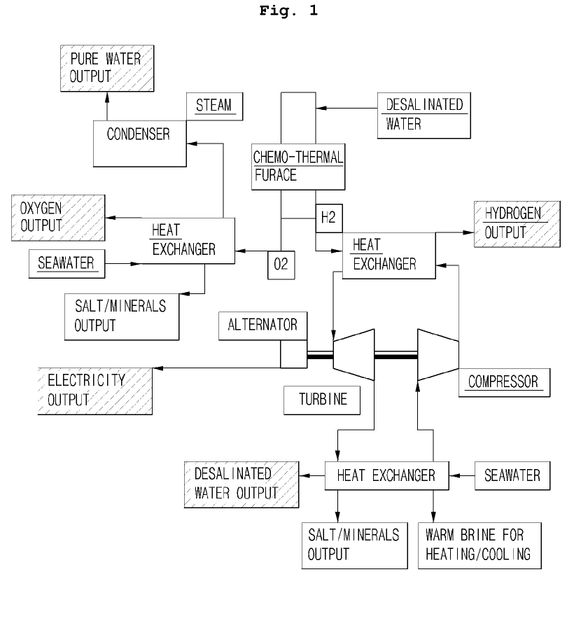

FIG. 2 is a diagram illustrating an integrated process for water, hydrogen, and electricity using a high temperature gas-cooled nuclear reactor as a single heat source according to an embodiment of the present invention;

FIG. 3 is a diagram illustrating an integrated process for water, hydrogen, and electricity using a high temperature gas-cooled nuclear reactor as a single heat source according to another embodiment of the present invention;

FIG. 4 is a diagram illustrating an integrated process for electricity and hydrogen using a high temperature gas-cooled reactor as a single heat source according to an embodiment of the present invention;

FIG. 5 is a diagram illustrating an integrated process for electricity and hydrogen using a high temperature gas-cooled nuclear reactor as a single heat source according to another embodiment of the present invention;

FIG. 6 is a diagram illustrating an integrated process for electricity and water using a high temperature gas-cooled nuclear reactor as a single heat source according to an embodiment of the present invention; and

FIG. 7 is a diagram illustrating an integrated process for electricity and water using a high temperature gas-cooled nuclear reactor as a single heat source according to another embodiment of the present invention.

### BRIEF DESCRIPTION OF THE MARK OF DRAWINGS

10: helium (He)

11′: first circulating loop

11″: second circulating loop

12: communicating part

13: fluid distributor

14′: first fluid regulator

14″: second fluid regulator

15: helium (He), CO₂, N₂ or Gas Mixture

20: First Working Fluid

30: Fresh Water

40: Salt Water

50: H₂

60: O₂

70: Electricity

80: Second Working Fluid

90: Cooling Water

100: High Temperature Gas-cooled Reactor

110: First Intermediate Heat Exchanger

120: Second Intermediate Heat Exchanger

200: Power Conversion Unit

210: Gas Turbine

220: Recuperator

230: Precooler

240: Low Pressure Compressor

250: Intercooler

260: High Pressure Compressor

270: Electric Generator

300: Hydrogen Production Unit

310: Hydrogen Storage

320: Oxygen Storage

400: Electrical Desalination Unit

410: Thermal Desalination Unit

420: Salt Water Storage

430: Fresh Water Storage

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical sprit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

Hereinafter, the embodiments of the present invention will be described with reference to the accompanying drawings.

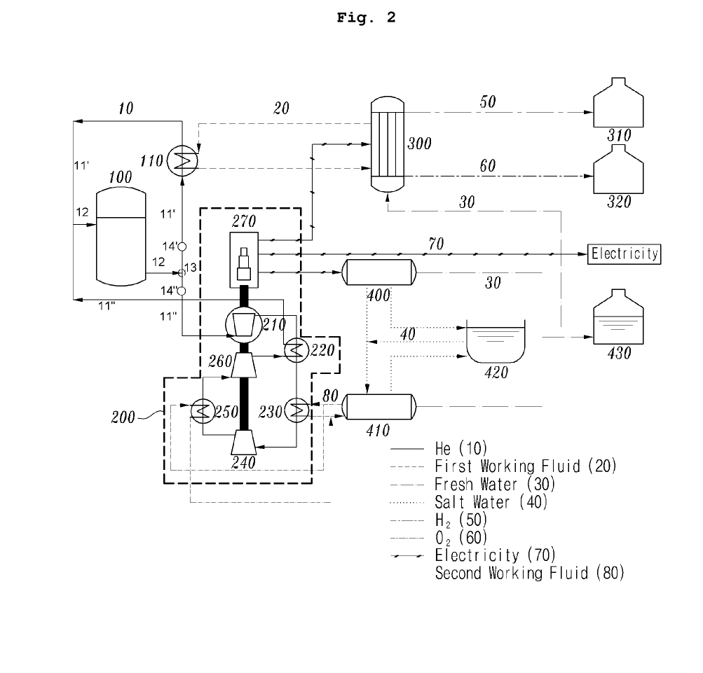

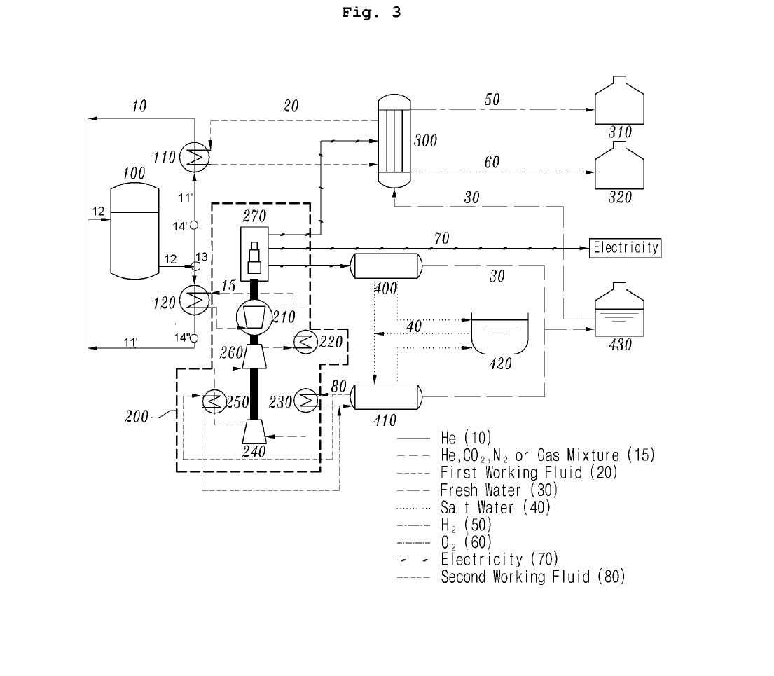

FIGS. 2 and 3 show an integrated process for electricity, hydrogen, and fresh water (hereinafter, referred merely as ‘water’) according to one embodiment of the present invention.

As shown in FIGS. 2 and 3, the integrated process is achieved by a high temperature gas cooled reactor 100 that produces a high-temperature heat source by using helium (He) 10 as a primary working fluid, a power conversion unit 200 connected directly or indirectly with the high-temperature gas-cooled reactor 100 to receive heat produced by a reactor core of the high-temperature gas-cooled reactor 100 and drive a gas turbine 210 by the heat, thereby producing electricity 70 through an electric generator 270, a hydrogen production unit 300 that produces hydrogen 50 by receiving the heat produced by the high-temperature gas-cooled reactor 100 and/or the electricity 70 produced by the electric generator 270, an electrical desalination unit 400 that produces water 30 using the electricity 70 produced by the electric generator 270, and a thermal desalination unit 410 that produces water by distilling water from salt water with waste heat recovered from a precooler 230 and an intercooler 250 of the power conversion unit 200.

The primary working fluid of helium (He) flows through a primary closed loop comprising at least two circulating loops, wherein each of at least two circulating loops may be in communication with each other.

In an example embodiment, said primary closed loop comprises a first circulating loop 11′ and a second circulating loop 11″, the primary closed loop may further comprises a communicating part 12, where said first circulating loop 11′ can be in communication with the second circulating loop 11″.

The primary closed loop may further comprise a fluid distributor 13 which distributes the primary working fluid into two circulating loops. In one embodiment of the present invention, each of the first and second circulating loop may comprise each fluid regulator, or a first fluid regulator 14′ and a second fluid regulator 14″. Each regulator regulates the flow rate of the primary working fluid which flows through each circulating loop. It is possible to regulate the ratio of the primary working fluid which flows through the first circulating loop 11′ to the primary working fluid which flows through the second circulating loop 11″ through the regulators. Typically, the communicating part 12 passes through the high-temperature gas-cooled reactor 100, and the fluid distributor 13 is located downstream of the high-temperature gas-cooled reactor 100 and at one end of the communicating part 12 to the downstream of the high-temperature gas-cooled reactor 100.

In other embodiment of the present invention, the distributor 13 comprises a T-shaped pipe, a Y-shaped pipe, although not limited thereto, and the first and second regulator comprises a valve installed in each of circulating loops.

In another embodiment of the present invention, the second circulating loop may further comprise a circulator (not shown in drawings) which can provides additional driving force to circulate the primary working fluid through the first circulating loop, and the circulator may comprises a pump, although not limited thereto.

The power conversion unit 200 includes the gas turbine 210, a recuperator 220, the precooler 230, a low pressure compressor 240, the intercooler 250, a high pressure compressor 260, and the electric generator 270. The power conversion unit 200 produces electricity through the electric generator 270 by operating the gas turbine 210 by receiving heat produced by the high-temperature gas-cooled reactor 100 from the second circulating loop 11″. Here, the power conversion unit 200 may use a direct cycle (see FIG. 2) that directly uses the primary working fluid of the high-temperature gas-cooled reactor 100 as a working fluid of the power conversion unit 200, or an indirect cycle (see FIG. 3) that transfers heat produced by the high-temperature gas-cooled reactor 100 to the power conversion unit 200 through a second intermediate heat exchanger 120 and uses helium (He), CO₂, N₂, or a mixture of them 15 as a secondary working fluid of the power conversion unit 200. The electricity produced by the electric generator 270 may be supplied to each home, or transferred to the desalination unit and/or the hydrogen production unit 300 to be used for production of water and/or hydrogen.

The hydrogen production unit 300 produces hydrogen by receiving heat produced by the high-temperature gas-cooled reactor from the first circulating loop 11′, or indirectly receiving the heat from the first circulating loop 11′ through a first intermediate heat exchanger 110 or receiving the electricity generated from the electric generator 270. The hydrogen production unit 300 comprises a thermo-chemical reactor or an electrolyzer. And the process how the hydrogen production unit 300 produces hydrogen may be a thermo-chemical process, an electrolysis process, a hybrid process, a high-temperature steam electrolysis process, and so forth although not limited thereto. Hydrogen and oxygen are produced as the water is decomposed in the hydrogen production unit 300. The hydrogen is transferred to a hydrogen storage 310 and the oxygen is transferred to an oxygen storage 320.

The desalination unit includes the electrical desalination unit 400 that produces water from salt water by using the electricity produced by the electric generator 270, and the thermal desalination unit 410 that produces water by recovering waste heat from the precooler 230 and the intercooler 250, evaporating water from salt water by the waste heat, and then condensing steam.

The electrical desalination unit 400 may comprises a reverse osmosis (RO) plant, a forward osmosis (FO) plant, or a capacitive deionization (CDI) plant, although not limited thereto. The process how the electrical desalination unit 400 produces water may be a reverse osmosis (RO) process, a forward osmosis (FO) process, a capacitive deionization (CDI) process, and so forth. The thermal desalination unit 410 may comprises a multi-stage flash distillation (MSF) plant, or a multiple effect distillation (MED) plant, although not limited thereto. The process how the electrical desalination unit 400 produces water may be a multi-stage flash distillation (MSF) process, a multiple effect distillation (MED) process, and so forth. However, the water production processes are not limited thereto.

The water produced by the desalination unit may be transferred to a water storage 430 to be used for production of hydrogen.

Concerning the integrated process for generation of electricity, hydrogen, and water according to the embodiment of the present invention, since the power conversion unit, the hydrogen production unit, and the desalination unit are integrated into a single system, production quantities of electricity, hydrogen, and water may be optimally adjusted according to users' demands.

According to a first method for this, when the helium (He) which flows from the high-temperature gas-cooled reactor 100 is moving to the first intermediate heat exchanger 110 for production of hydrogen, or is moving to the gas turbine 210 (FIG. 2) or the second intermediate heat exchanger 120 (FIG. 3) for production of electricity and water, a flow ratio of helium (He) is increased to a process requiring a higher production quantity. Thus, the production quantities of the electricity, hydrogen, and water may be adjusted as demanded.

According to a second method, the electricity 70 produced by the electric generator 270 is supplied back to the hydrogen production unit 300 or the electrical desalination unit 400 and used for production of hydrogen or water. Accordingly, the production quantities may be adjusted as demanded.

For example, in an area where demand for water is higher than for electricity and hydrogen, the He 10 which flows from the high-temperature gas-cooled reactor 100 is supplied more to the gas turbine 210 (FIG. 2) or the second intermediate heat exchanger 120 (FIG. 3) for production of electricity and water than to the first intermediate heat exchanger 110 for production of hydrogen. In addition, the electricity produced by the electric generator 270 is mainly used for the desalination unit. Accordingly, users' demands can be met.

Furthermore, the integrated process for electricity, hydrogen, and water according to the embodiment of the present invention is capable of storing surplus energy.

More specifically, considering that the power conversion unit, the hydrogen production unit, and the desalination unit are integrated into the single system according to the integrated process, during the time such as night or weekends when demand for electricity or water is relatively low, the He 10 which flows from the high-temperature gas-cooled reactor 100 may be mostly supplied to the first intermediate heat exchanger 110 for production of hydrogen so that the surplus energy (heat energy) may be stored in the form of hydrogen energy.

In addition, since the integrated process according to the embodiment of the present invention uses one heat source for multiple purposes, inefficient use of heat, that may be caused when electricity, hydrogen, and water production processes are all separated, is minimized. That is, heat utilization rate can be considerably increased.

Also, the integrated process according to the embodiment of the present invention may be altered to an integrated process for production of electricity and hydrogen or an integrated process for production of electricity and water.

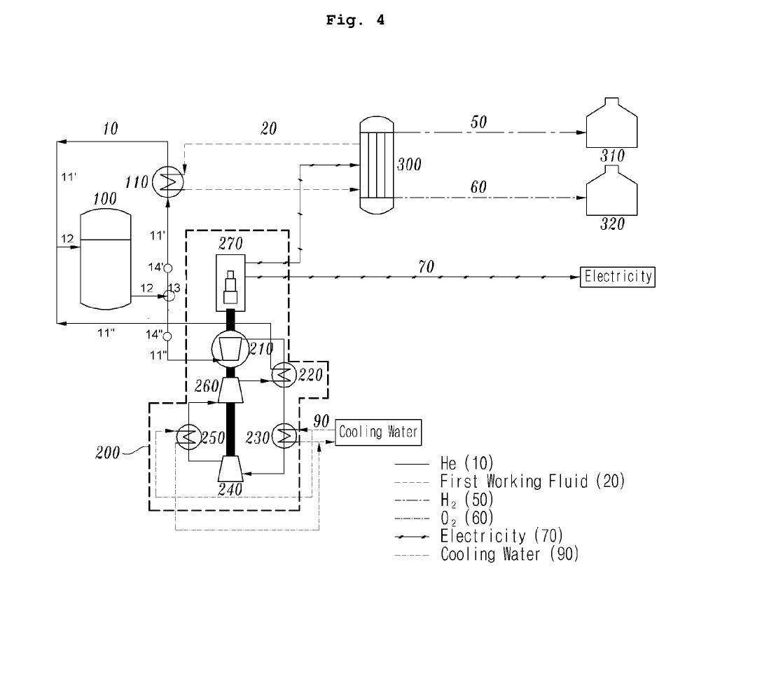

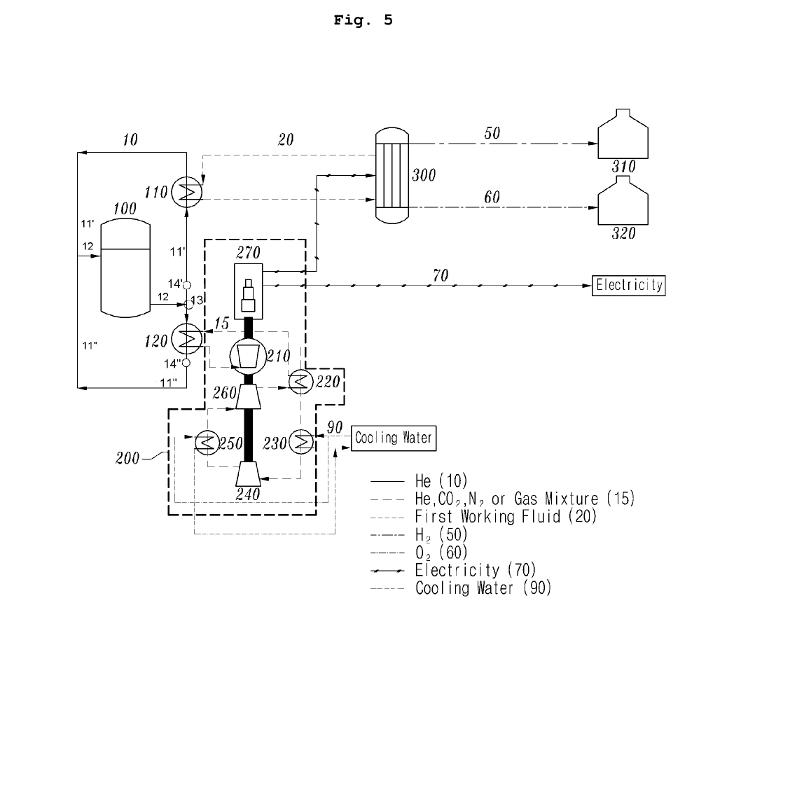

The integrated process for electricity and hydrogen according to one embodiment of, as shown in FIGS. 4 and 5, is achieved by the high-temperature gas-cooled reactor 100 that produces a high-temperature heat source by using the helium (He) 10 as a primary working fluid, the power conversion unit 200 connected directly or indirectly with the high-temperature gas-cooled reactor 100 to receive heat produced by the reactor core of the high-temperature gas-cooled reactor 100 and drive the gas turbine 210 by the heat, thereby producing the electricity 70 through the electric generator 270, the hydrogen production unit 300 that produces the hydrogen 50 by receiving heat produced by the high-temperature gas-cooled reactor 100 and/or the electricity 70 produced by the electric generator 270.

The primary working fluid of helium (He) flows through a primary closed loop comprising at least two circulating loops, wherein each of at least two circulating loops may be in communication with each other.

In an example embodiment, said primary closed loop comprises a first circulating loop 11′ and a second circulating loop 11″, the primary closed loop may further comprises a communicating part 12, where said first circulating loop 11′ can be in communication with the second circulating loop 11″.

The primary closed loop may further comprise a fluid distributor 13 which distributes the primary working fluid into two circulating loops. In one embodiment of the present invention, each of the first and second circulating loop may comprise each fluid regulator, or a first fluid regulator 14′ and a second fluid regulator 14″. Each regulator regulates the flow rate of the primary working fluid which flows through each circulating loop. It is possible to regulate the ratio of the primary working fluid which flows through the first circulating loop 11′ to the primary working fluid which flows through the second circulating loop 11″ through the regulators. Typically, the communicating part 12 passes through the high-temperature gas-cooled reactor 100, and the fluid distributor 13 is located downstream of the high-temperature gas-cooled reactor 100 and at one end of the communicating part 12 to the downstream of the high-temperature gas-cooled reactor 100.

In other embodiment of the present invention, the distributor 13 comprises a T-shaped pipe, a Y-shaped pipe, although not limited thereto, and each of the first and second regulator comprises a valve installed in each of circulating loops.

In another embodiment of the present invention, the second circulating loop may further comprise a circulator (not shown in drawings) which can provides additional driving force to circulate the primary working fluid through the first circulating loop, and the circulator may comprises a pump, although not limited thereto.

The power conversion unit 200 includes the gas turbine 210, the recuperator 220, the precooler 230, the low pressure compressor 240, the intercooler 250, the high pressure compressor 260, and the electric generator 270. The power conversion unit 200 generates electricity through the electric generator 270 by operating the gas turbine 210 by receiving heat produced by the high-temperature gas-cooled reactor 100 from the second circulating loop 11″. Here, the power conversion unit 200 may use a direct cycle (see FIG. 4) that directly uses the primary working fluid of the high-temperature gas-cooled reactor 100 as a working fluid of the power conversion unit 200, or an indirect cycle (see FIG. 5) that transfers heat produced by the high-temperature gas-cooled reactor 100 to the power conversion unit 200 through the second intermediate heat exchanger 120 and uses helium (He), CO₂, N₂, or a mixture of them 15 as a secondary working fluid of the power conversion unit 200. The electricity produced by the electric generator 270 may be supplied to each home, or transferred to the hydrogen production unit 300 to be used for production of hydrogen.

The hydrogen production unit 300 produces hydrogen by receiving heat produced by the high-temperature gas-cooled reactor from the first circulating loop 11′, or indirectly receiving the heat from the first circulating loop 11′ through a first intermediate heat exchanger 110 or receiving the electricity generated from the electric generator 270. The hydrogen production unit 300 comprises a thermo-chemical reactor or an electrolyzer. And the process how the hydrogen production unit 300 produces hydrogen may be a thermo-chemical process, an electrolysis process, a hybrid process, a high-temperature steam electrolysis process, and so forth although not limited thereto. Hydrogen and oxygen are produced as the water is decomposed in the hydrogen production unit 300. The hydrogen is transferred to a hydrogen storage 310 and the oxygen is transferred to an oxygen storage 320.

According to the above process, production ratio between the electricity and the hydrogen may be optimally adjusted according to users' demands. Also, surplus energy may be stored in the form of the hydrogen energy at night or on weekends when the demand for electricity is relatively low. Moreover, since one heat source is utilized for multiple purposes, inefficient use of heat, that may be caused when electricity and hydrogen production processes are all separated, is minimized. That is, heat utilization rate can be considerably increased.

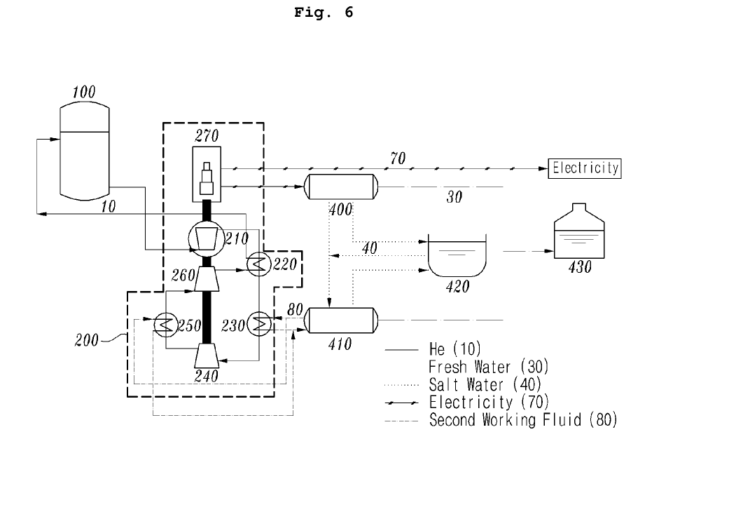

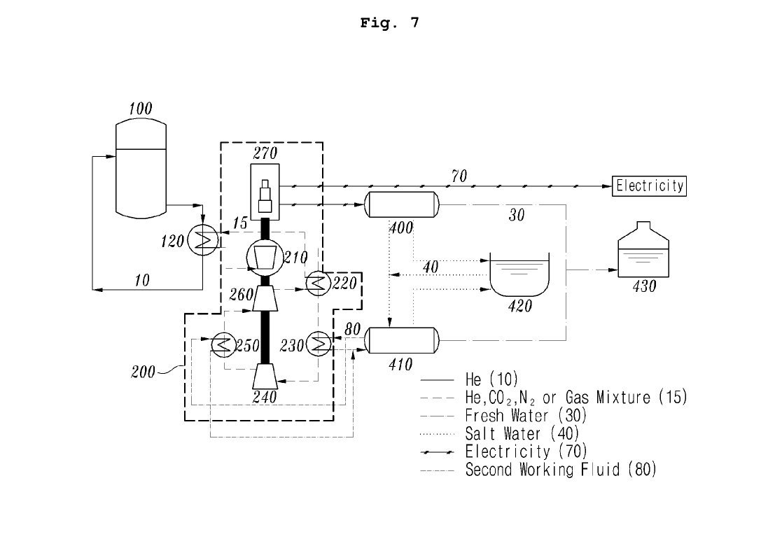

The integrated process for production of electricity and water, according to an embodiment of the present invention as shown in FIGS. 6 and 7, may be achieved by the high-temperature gas-cooled reactor 100 that produces a high-temperature heat source by using the helium (He) 10 as a primary working fluid, the power conversion unit 200 connected directly or indirectly with the high-temperature gas-cooled reactor 100 to receive heat produced by the reactor core of the high-temperature gas-cooled reactor 100 and drive the gas turbine 210 by the heat, thereby producing the electricity 70 through the electric generator 270, the electrical desalination unit 400 that produces the water 30 using the electricity 70 produced by the electric generator 270, and the thermal desalination unit 410 that produces water by distilling water from salt water with waste heat recovered from the precooler 230 and the intercooler 250 of the power conversion unit 200.

The primary working fluid of helium (He) flows through a primary closed loop comprising at least one circulating loop.

The power conversion unit 200 includes the gas turbine 210, the recuperator 220, the precooler 230, the low pressure compressor 240, the intercooler 250, the high pressure compressor 260, and the electric generator 270. The power conversion unit 200 generates electricity through the electric generator 270 by operating the gas turbine 210 by receiving heat produced by the high-temperature gas-cooled reactor 100 from the primary closed loop. Here, the power conversion unit 200 may use a direct cycle (see FIG. 6) that directly uses the working fluid of the high-temperature gas-cooled reactor 100 as a primary working fluid of the power conversion unit 200, or an indirect cycle (see FIG. 7) that transfers heat produced by the high-temperature gas-cooled reactor 100 to the power conversion unit 200 through the second intermediate heat exchanger 120 and uses helium (He), CO₂, N₂, or a mixture of them 15 as a secondary working fluid of the power conversion unit 200. The electricity produced by the electric generator 270 may be supplied to each home, or transferred to the desalination unit to be used for production of water.

The desalination unit includes the electrical desalination unit 400 that produces water from salt water by using the electricity produced by the electric generator 270, and the thermal desalination unit 410 that produces water by recovering waste heat from the precooler 230 and the intercooler 250, evaporating water from salt water by the waste heat, and then condensing steam.

The electrical desalination unit 400 may comprises a reverse osmosis (RO) plant, a forward osmosis (FO) plant, or a capacitive deionization (CDI) plant, although not limited thereto. The process how the electrical desalination unit 400 produces water may be the RO process, the FO process, the CDI process, and so forth. The thermal desalination unit 410 may comprises a multi-stage flash distillation (MSF) plant, a multiple effect distillation (MED) plant, although not limited thereto. The process how the electrical desalination unit 400 produces water may be the multi-stage flash distillation (MSF) process, the multiple effect distillation (MED) process, and so forth. However, the water production processes are not limited thereto.

The water produced by the desalination unit is transferred to the water storage 430.

According to the above-introduced processes, production quantities of electricity and water can be adjusted to optimal conditions. When demand for electricity is relatively low, for example at night or on weekends, surplus electricity may be used for production of water, thereby increasing the utilization. Moreover, since one heat source is used for multiple purposes, inefficient use of heat, that may be caused when electricity, hydrogen, and water production processes are all separated, is minimized. That is, heat utilization rate can be considerably increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated system for production of electricity, hydrogen, and water using a high-temperature gas-cooled reactor as a single source, comprising:
the high-temperature gas-cooled reactor comprising a reactor core, wherein the high temperature gas-cooled reactor produces a high-temperature heat source by using helium (He) as a primary working fluid;
a power conversion unit comprising a gas turbine, a precooler, a intercooler and an electric generator, wherein the power conversion unit generates electricity through an electric generator by directly receiving heat produced by the reactor core of the high-temperature gas-cooled reactor in direct connection with the high-temperature gas-cooled reactor and thereby driving the gas turbine by the heat;
a hydrogen production unit that produces hydrogen by receiving the heat produced by the high-temperature gas-cooled reactor and/or the electricity produced by the electric generator;
a primary closed loop employs the primary working fluid, wherein the closed loop comprises a first circulating loop, a second circulating loop, and a communicating part where the first circulating loop communicates with the second circulating loop,
an electrical desalination unit that produces water using electricity produced by the electric generator; and
a thermal desalination unit that produces water by distilling water from salt water with waste heat recovered from the precooler and the intercooler of the power conversion unit,
wherein the power conversion unit receives the heat from the second circulating loop and the hydrogen production unit receives the heat from the first circulating loop.

2. The integrated system as set forth in claim 1, wherein the hydrogen production unit produces hydrogen by receiving water produced by the desalination unit and decomposing the water.

3. The integrated system as set forth in claim 1, wherein the hydrogen production unit comprises a thermo-chemical reactor and/or an electrolyzer.

4. The integrated system as set forth in claim 1, wherein the electrical desalination unit comprises a reverse osmosis (RO) plant, a forward osmosis (FO) plant, or a capacitive deionization (CDI) plant.

5. The integrated system as set forth in claim 1, wherein the thermal desalination unit comprises a multi-stage flash distillation (MSF) plant or a multiple effect distillation (MED) plant.

6. The integrated system as set forth in claim 1, wherein the integrated system is capable of adjusting production quantities of electricity, hydrogen, and water according to users' demands by increasing a flow ratio of the helium (He) which flows from the high-temperature gas-cooled reactor to the one which requires a higher production quantity between the two: the hydrogen production unit and the power conversion unit which is coupled with the thermal desalination unit, or by supplying the electricity produced by the electric generator to the hydrogen production unit or the electrical desalination unit so that the electricity is used for production of hydrogen or water.

7. The integrated system as set forth in claim 1, wherein the first circulating loop and the second circulating loop comprises a first fluid regulator and a second fluid regulator respectively, which regulate the ratio of the primary working fluid which flows through the first working fluid to the primary working fluid which flows through the second working fluid.

8. The integrated system as set forth in claim 1, wherein, the system further comprises an intermediate heat exchanger between the high-temperature gas-cooled reactor and the power conversion unit, and,
the power conversion unit generates electricity through the electric generator by indirectly receiving heat produced by the high-temperature gas-cooled reactor through the intermediate heat exchanger and a secondary working fluid comprising helium (He), CO₂, N₂, or a mixture of those gases and thereby driving the gas turbine by the heat.

9. An integrated system for production of electricity and hydrogen using a high-temperature gas-cooled reactor as a single heat source, comprising:
the high-temperature gas-cooled reactor comprising a reactor core, wherein the high-temperature gas-cooled reactor produces a high-temperature heat source by using helium (He) as a primary working fluid;
a power conversion unit comprising a gas turbine, a precooler, an intercooler and an electric generator, wherein the power conversion unit generates electricity through an electric generator by directly receiving heat produced by the reactor core of the high-temperature gas-cooled reactor in direct connection with the high-temperature gas-cooled reactor and thereby driving the gas turbine by the heat;
a hydrogen production unit that produces hydrogen by receiving the heat produced by the high-temperature gas-cooled reactor and/or the electricity produced by the electric generator; and
a primary closed loop employs the primary working fluid, wherein the closed loop comprises a first circulating loop, a second circulating loop, and a communicating part where the first circulating loop communicates with the second circulating loop, and
wherein the power conversion unit receives the heat from the second circulating loop and the hydrogen production unit receives the heat from the first circulating loop.

10. The integrated system as set forth in claim 9, wherein the hydrogen production unit comprises a thermo-chemical reactor and/or an electrolyzer.

11. The integrated system as set forth in claim 9, wherein the integrated system is capable of adjusting production quantities of electricity and hydrogen according to users' demands by increasing a flow ratio of the helium (He) which flows from the high-temperature gas-cooled reactor to the one which requires a higher production quantity between the two: the hydrogen production unit and the power conversion unit, or by supplying the electricity produced by the electric generator to the hydrogen production unit so that the electricity is used for production of hydrogen.

12. The integrated system as set forth in claim 9, wherein the first circulating loop and the second circulating loop comprises a first fluid regulator and a second fluid regulator respectively, which regulate the ratio of the primary working fluid which flows through the first working fluid to the primary working fluid which flows through the second working fluid.

13. The integrated system as set forth in claim 9, wherein, the system further comprises an intermediate heat exchanger between the high-temperature gas-cooled reactor and the power conversion unit, and
the power conversion unit generates electricity through the electric generator by indirectly receiving heat produced by the high-temperature gas-cooled reactor through the intermediate heat exchanger and a secondary working fluid comprising helium (He), CO₂, N₂, or a mixture of those gases and thereby driving the gas turbine by the heat.

14. An integrated system for production of electricity and water using a high-temperature gas-cooled reactor as a single heat source, comprising:
the high-temperature gas-cooled reactor comprising a reactor core, wherein the high-temperature gas-cooled reactor produces a high-temperature heat source by using helium (He) as a primary working fluid;
a power conversion unit comprising a gas turbine, a precooler, an intercooler and an electric generator, wherein the power conversion unit generates electricity through an electric generator by directly receiving heat produced by the reactor core of the high-temperature gas-cooled reactor in direct connection with the high-temperature gas-cooled reactor and thereby driving the gas turbine by the heat;
an electrical desalination unit that produces water using electricity produced by the electric generator; and
a thermal desalination unit that produces water by distilling water from salt water with waste heat recovered from the precooler and the intercooler of the power conversion unit.

15. The integrated system as set forth in claim 14, wherein the electrical desalination unit comprises a reverse osmosis (RO) plant, a forward osmosis (FO) plant, or a capacitive deionization (CDI) plant.

16. The integrated system as set forth in claim 14, wherein the thermal desalination unit produces water by a multi-stage flash distillation (MSF) plant or a multiple effect distillation (MED) plant.

17. The integrated system as set forth in claim 14, wherein the integrated system is capable of adjusting production quantities of electricity and water according to users' demands by supplying the electricity produced by the electric generator to the electrical desalination unit so that the electricity is used for production of water.

18. The integrated system as set forth in claim 14, wherein surplus electricity is efficiently used for production of water when demand for electricity reduces.

19. The integrated system as set forth in claim 14, wherein, the system further comprises an intermediate heat exchanger between the high-temperature gas-cooled reactor and the power conversion unit, and the power conversion unit generates electricity through the electric generator by indirectly receiving heat produced by the high-temperature gas-cooled reactor through the intermediate heat exchanger and a secondary working fluid comprising helium (He), CO₂, N₂, or a mixture of those gases and thereby driving the gas turbine by the heat.
